(19) United States
(12) Patent Application Publication
(10) Pub. No.: US 2026/0366630 A1
(43) Pub. Date: Nov. 19, 2026

(54) CHECK VALVE

(71) Applicants: HYUNDAI MOTOR COMPANY, Seoul (KR); Kia Corporation, Seoul (KR); TAEKWANGFUJIKIN CO.,LTD, Busan (KR)

(72) Inventors: Jae Jun LEE, Hwaseong-si (KR); Yong Ki KIM, Busan (KR); Sung Jun AHN, Busan (KR); Min Kyun HWANG, Busan (KR); Gyung Hyun GONG, Busan (KR)

(21) Appl. No.: 19/467,112

(22) Filed: Feb. 2, 2026

(30) Foreign Application Priority Data
May 14, 2025 (KR) 10-2025-0062806

(51) Int. Cl. F16K 15/02; F17C 13/04

(52) U.S. Cl. CPC F16K 15/026; F17C 13/04; F17C 2205/0335

(57) ABSTRACT

A check valve according to the present disclosure may include a connector that includes an inlet port; a housing coupled to an inner lower portion of the connector and configured to couple to an external pipe; a seat disposed between the inner lower portion of the connector and an inner upper portion of the housing; a poppet configured to open or close a first flow path; a gasket provided at an upper portion of the poppet and attached to the seat; a spring disposed in the internal space of the housing and configured to apply an elastic force to the poppet in a direction in which the poppet closes the first flow path; and a ventilation hole formed in at least one of the seat or the poppet.

### CROSS-REFERENCE TO RELATED APPLICATION

This application claims priority to and the benefit of Korean Patent Application No. 10-2025-0062806, filed in the Korean Intellectual Property Office on May 14, 2025, the entire contents of which are incorporated herein by reference.

### TECHNICAL FIELD

The present disclosure relates to vehicle components, and more particularly to a check valve in a fuel receptacle of a vehicle.

### BACKGROUND

A check valve allows a fluid to flow only in one direction and prevents the fluid from flowing in the opposite direction. The check valve may play a critical role in hydrogen vehicles such as fuel cell electric vehicles (FCEVs). In particular, because the check valve is required to operate reliably within a wide range of pressure (e.g., from about 5 bar to a maximum pressure of 875 bar), sealability needs to be ensured in an overall region of the check valve.

A sealing part of the check valve may include a material having elasticity to ensure a close-contact force. The higher the elasticity, the better the achieved performance may be even with a low spring load. However, because the material with high elasticity tends to have low durability, there is a concern that damage might occur during repeated operations of the check valve through repeated refueling. Some implementations of check valves may utilize a plastic-metal combination to achieve excellent durability. In this case, the spring may be designed to have comparatively high tension.

However, higher spring tension may affect the state of fill (SOF) of the vehicle’s fuel due to a pressure difference during filling, and may cause a poppet of the valve to shake when a fluid is flowing through the valve, which may cause a chattering noise. The chattering refers to the noise that is caused by repeated contact between metals. The chattering may degrade a vehicle’s noise profile and adversely affect marketability of vehicles. As described above, a check valve may have a trade-off problem between sealability, durability, SOF, and chattering.

The matters described in this Background section are only for enhancement of understanding of the background of the disclosure, and should not be taken as acknowledgement that they correspond to prior art already known to those skilled in the art.

### SUMMARY

An object of the present disclosure is to provide a check valve capable of improving sealability and chattering suppression performance by means of a gasket, which is disposed above a poppet, and a ventilation hole, which is formed in a poppet seat, and ensuring durability even in a repetitive operational environment by applying the corresponding structure as a stopper, thereby maintaining stable sealability and providing chattering suppression performance within a wide pressure range.

According to one or more example embodiments of the present disclosure, a check valve may include a connector that includes an inlet port. The inlet port may be configured to receive a fluid therethrough. A first flow path may be formed in the connector. The check valve may further include: a housing coupled to an inner lower portion of the connector and configured to couple to an external pipe; a seat disposed between the inner lower portion of the connector and an inner upper portion of the housing; and a poppet movably disposed in an internal space of the housing. The poppet may be configured to: close the first flow path based on the poppet being attached to the seat, or open the first flow path based on the poppet being detached from the seat. The check valve may further include: a gasket provided at an upper portion of the poppet and attached to the seat; a spring disposed in the internal space of the housing and configured to apply an elastic force to the poppet in a direction in which the poppet closes the first flow path; and a ventilation hole formed in at least one of the seat or the poppet.

The ventilation hole may be formed in a region in which, based on the poppet being positioned to attach to the seat, the upper portion of the poppet adjoins an upper portion of the seat to allow the upper portion of the poppet to communicate with the upper portion of the seat.

An inner peripheral surface of the seat may face the poppet and has a recessed section that is recessed inward. The ventilation hole may be formed at a space between the recessed section and the poppet.

The recessed section may be formed in a section having a partial angular position around a central axis of the seat.

An inner peripheral surface of the upper portion of the poppet may face the seat and has a recessed section that is recessed inward. The ventilation hole may be formed at a space between the recessed section and the seat.

The recessed section may be formed in a section having a partial angular position around a central axis of the poppet.

The seat may be integrated with the connector and forms a ridge on the inner lower portion of the connector.

An inner peripheral surface of the seat may face the poppet and has a recessed section that is recessed inward. The ventilation hole may be formed at a space between the recessed section and the poppet.

The recessed section may be formed in a section having a partial angular position around a central axis of the connector.

A lower portion of the connector may form a sleeve around at least a part of the housing.

A groove may be formed along an outer peripheral surface of the upper portion of the poppet. The gasket may be inserted into the groove and disposed in a ring shape along the outer peripheral surface of the upper portion of the poppet.

An upper portion of the groove may have a smaller depth than a lower portion of the groove.

The connector may include: a first flow path portion disposed on a central portion of the connector and forming at least part of the first flow path; an upper end inclined expansion portion disposed at an upper end of the connector where a diameter of the first flow path expands toward the inlet port; and a lower end inclined expansion portion disposed at a lower end of the connector. The diameter of the first flow path may expand toward the inner lower portion of the connector.

An upper portion of the poppet may have a first inclined surface tapered toward a lower portion of the poppet. An upper portion of the seat may have a second inclined surface corresponding to the first inclined surface.

The first inclined surface may have an inclination angle of 30 degrees or more and 50 degrees or less with respect to a central axis of the poppet.

A lower portion of the seat may have a third inclined surface corresponding to a surface of the gasket. The third inclined surface may be formed to have a smaller angle than the first inclined surface with respect to a central axis of the poppet.

The ventilation hole may include a plurality of ventilation holes symmetrically disposed along an outer periphery of the poppet.

The poppet may include: a coupling portion formed on the upper portion of the poppet and coupled to the gasket; a second flow path formed on a central portion of the poppet and formed to be inclined downward and inward from an outer peripheral surface of the poppet to guide the fluid into an interior space of the poppet; and an accommodation groove formed on a lower portion of the poppet and opened so that at least a part of the spring is inserted into the accommodation groove. The accommodation groove may be configured to guide a flow of the fluid.

According to one or more example embodiments of the present disclosure, a check valve may include a connector through which a first flow path is formed. The connector may include: an inlet port coupled to the first flow path and configured to receive a liquid therethrough; and a sleeve disposed below the inlet port and including a tubular inner wall and an open bottom. The tubular inner wall of the sleeve may form an interior space, of the connector, that communicates with the first flow path. The check valve may further include a cylindrical housing disposed in the interior space of the sleeve and coupled to the tubular inner wall of the sleeve. A top portion of an inner wall of the cylindrical housing may be indented to form an indented portion of the cylindrical housing; and a seat disposed between the sleeve of the connector and the indented portion of the cylindrical housing. The seat may have a circular shape and a through hole. A diameter of the through hole may narrow toward a top of the seat and widen toward a bottom of the seat. An inner wall of the seat may have a recessed section that runs from the top of the seat to the bottom of the seat. The check valve may further include a poppet disposed inside the cylindrical housing and configured to: move to a closed valve position to: create a seal between the poppet and the seat and obstruct the first flow path, and form a ventilation hole between the poppet and the seat and along the recessed section of the seat, or move to an open valve position to break the seal between the poppet and the seat and unblock the first flow path.

A ring-shaped groove may be formed around the poppet. The poppet may include a gasket mounted along the ring-shaped groove. Based on the poppet being positioned at the closed valve position: the seal may be created between the gasket and the seat, and the recessed section of the seat is not in contact with the poppet.

### BRIEF DESCRIPTION OF THE DRAWINGS

FIG. 1 is a block diagram illustrating an example check valve of a hydrogen storage system.

FIG. 2 is a perspective view illustrating an example check valve.

FIG. 3 is an exploded perspective view illustrating an example check valve.

FIG. 4 is a cross-sectional view illustrating an example check valve where a first flow path is closed.

FIG. 5 is a cross-sectional view illustrating an example check valve where a first flow path is opened.

FIG. 6 is an enlarged cross-sectional view illustrating a close-contact region between a seat and a poppet where a first flow path is closed.

FIG. 7 is a top plan view illustrating the seat of an example check valve when viewed from the lower side looking up.

FIG. 8 is a perspective view illustrating the poppet according to the disclosed embodiment.

FIG. 9 is a cross-sectional view illustrating a plurality of second flow paths formed in a central portion of the poppet in an example check valve.

FIG. 10 is a cross-sectional view illustrating a converging structure of the second flow paths in an example check valve.

FIG. 11 is an enlarged cross-sectional view illustrating a second inclined surface and a third inclined surface in an example check valve.

FIG. 12 is a cross-sectional view illustrating an example check valve, in which a connector and a seat are integrated.

FIG. 13 is a cross-sectional view illustrating an example check valve with a ventilation hole formed in a poppet.

### DETAILED DESCRIPTION

Hereinafter, one or more example embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of example embodiment(s), a detailed description of related publicly-known configurations or functions may be omitted when it is determined that the detailed description obscures the understanding of the example embodiment(s).

In addition, the terms first, second, A, B, (a), and (b) may be used to describe constituent elements of example embodiment(s). These terms are used only for the purpose of discriminating one constituent element from another constituent element, and the nature, the sequences, or the orders of the constituent elements are not limited by the terms. Further, unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

Hereinafter, a check valve 100 according to the present disclosure will be described with reference to the drawings.

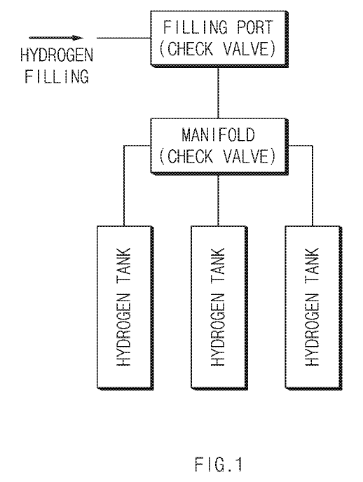

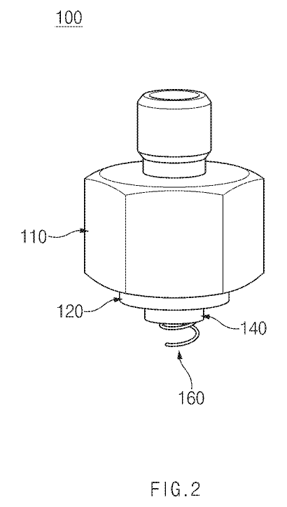

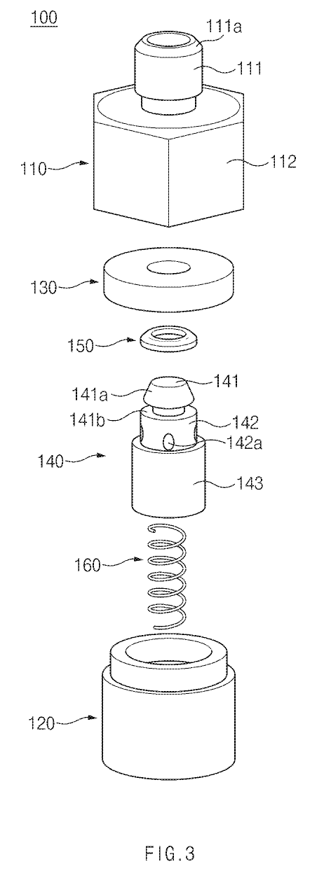

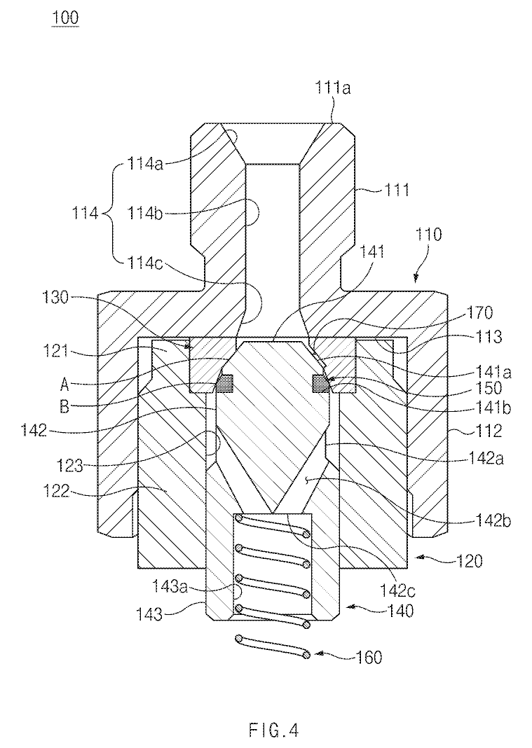

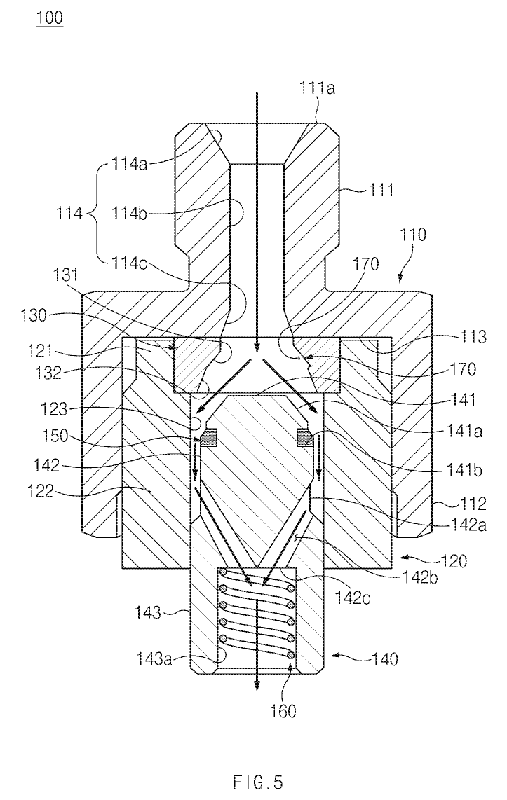

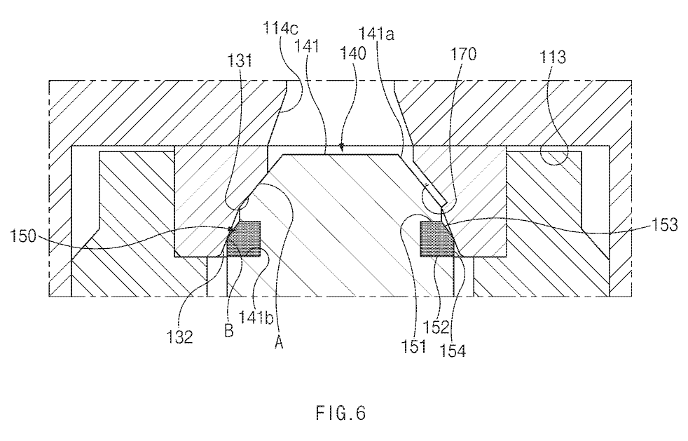

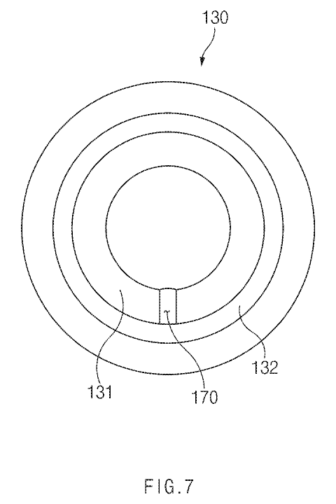

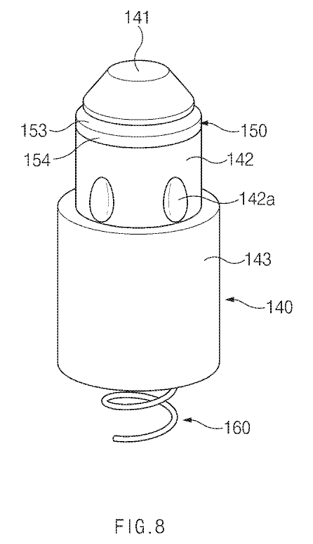

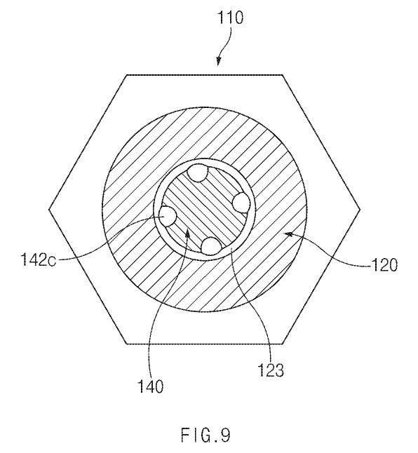

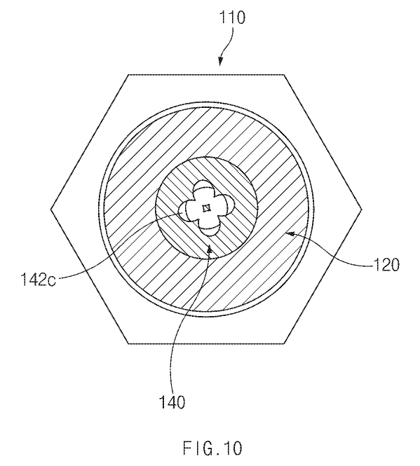

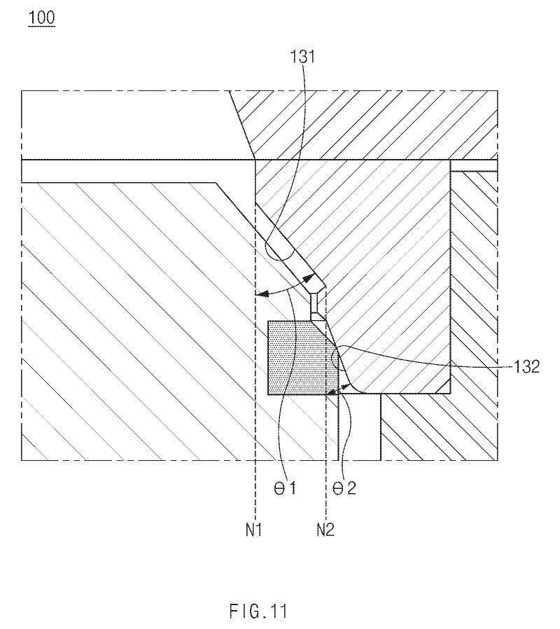

FIG. 1 is a block diagram illustrating an example check valve of a hydrogen storage system. FIG. 2 is a perspective view illustrating an example check valve. FIG. 3 is an exploded perspective view illustrating an example check valve. FIG. 4 is a cross-sectional view illustrating an example check valve where a first flow path is closed. FIG. 5 is a cross-sectional view illustrating an example check valve where a first flow path is opened. FIG. 6 is an enlarged cross-sectional view illustrating a close-contact region between a seat and a poppet where a first flow path is closed. FIG. 7 is a top plan view illustrating the seat of an example check valve when viewed from the lower side looking up. FIG. 8 is a perspective view illustrating the poppet according to the disclosed embodiment. FIG. 9 is a cross-sectional view illustrating a plurality of second flow paths formed in a central portion of the poppet in an example check valve. FIG. 10 is a cross-sectional view illustrating a converging structure of the second flow paths in an example check valve. FIG. 11 is an enlarged cross-sectional view illustrating a second inclined surface and a third inclined surface in an example check valve.

With reference to FIG. 1, the check valve 100 may be one of the constituent elements of a hydrogen storage system, and the check valve 100 may be applied to a hydrogen filling port and a manifold. For example, the hydrogen filling port may be positioned in a path through which hydrogen is introduced into a vehicle from the outside. The hydrogen filling port may use the check valve 100 to allow hydrogen to flow only in an introduction direction and block a reverse flow. In addition, the manifold refers to an intermediate path through which hydrogen is distributed to a plurality of hydrogen tanks. The manifold may also use the check valve 100 to prevent a reverse flow between the tanks and induce stable flow rate distribution. Therefore, the “hydrogen storage system” may not only simply include the tank but also include the components, such as the filling port and the manifold, in which the check valves 100 are installed.

With reference to FIGS. 2 to 11, the check valve 100 may include all or some of a connector 110, a housing 120, a seat 130, a poppet 140, a gasket 150, a spring 160, and a ventilation hole 170.

The connector 110 may include an inlet port 111a through which a fluid is introduced. Specifically, the inlet port 111a may be formed in an upper portion 111 of the connector. A first flow path 114, through which the fluid passes, may be formed in (e.g., through) the connector 110 in a longitudinal direction of the connector 110. For example, the connector 110 may be formed as a cylindrical or polyprismatic body as a whole. The inlet port 111 may be connected to (e.g., communicate with) the first flow path. The inlet port 111 may be configured to receive the liquid therethrough.

More specifically, all or some of a first flow path portion 114b, an upper end inclined expansion portion (also referred to as upper end inclined expansion portion) 114a, and a lower end inclined expansion portion (also referred to as lower end inclined expansion portion) 114c may be provided in the connector 110. The first flow path portion 114b, the upper end inclined expansion portion 114a, and the lower end inclined expansion portion 114c may be continuously connected.

The first flow path portion 114b may be disposed in a central region of the connector 110. The first flow path portion 114b may define the first flow path 114 that maintains a predetermined diameter.

The upper end inclined expansion portion 114a may be disposed in the upper portion 111 of the connector. Specifically, the upper end inclined expansion portion 114a may be inclined and expanded from an upper end (e.g., upper end or top end) of the first flow path portion 114b toward the outside of the inlet port 111a so that the fluid introduced into the inlet port 111a may more smoothly enter the inside of the check valve. In other words, the diameter of the first flow path 114 in the upper end inclined expansion portion 114a may expand toward the inlet port 111a.

The lower end inclined expansion portion 114c may be disposed in a lower portion 112 of the connector 110 and inclined and expanded from a lower end (e.g., lower end or bottom end) of the first flow path portion 114b toward an inner lower portion 113 of the connector 110 (e.g., an interior surface of a lower portion of the connector 110). In other words, the diameter of the first flow path 114 in the lower end inclined expansion portion 114c may expand toward the inner lower portion 113 of the connector 110. Therefore, a flow of the fluid may be gently maintained in a region in which the connector 110 and the housing 120 adjoin each other, thereby minimizing the flow resistance or the occurrence of a vortex.

The lower portion 112 of the connector 110 may form a sleeve (e.g., bushing, tubular cover, etc.) around at least a part of the upper portion 121 of the housing 120. The sleeve may be disposed below the inlet port 111a and include a tubular inner wall and an open bottom. The tubular inner wall of the sleeve may form an interior space of the connector 110. The interior space of the connector 110 may communicate with the first flow path 114.

The housing 120 may be coupled to the inner lower portion 113 of the connector. The housing 120 may have a structure configured to define a flow path so that the fluid introduced from the connector 110 is discharged to an external pipe through a lower portion 122 of the housing. The housing 120 may be a cylindrical housing. The housing 120 may be disposed in the interior space of the lower portion 112 (e.g., sleeve) of the connector 110. The housing 120 may be coupled to the tubular inner wall of the sleeve.

Specifically, the housing 120 may be formed to have a cylindrical or polyprismatic body and include a fastening structure, such as a threaded portion, a coupling protrusion, or a guide groove, on an outer peripheral surface or an inner peripheral surface of the housing 120 so that the housing 120 is coupled to the connector 110.

The housing 120 may be formed such that the upper portion (e.g., top portion) 121 of the housing 120 is inserted or fitted into the lower portion 112 of the connector 110 to ensure sealability and coupling force.

In addition, the lower portion 122 of the housing may be connected to the external pipe in various ways, such as screw-coupling, welding, flange-fastening, or the like. The lower portion 122 of the housing may be configured to stably transmit the fluid without a leak of the fluid even in a high-pressure environment.

A hollow structure may be formed in an internal space 123 of the housing and extend in a longitudinal direction of the housing 120 so that the poppet 140 may be inserted and move.

The seat 130 may be disposed between the inner lower portion 113 of the connector and an inner upper portion (also referred to as upper inner portion) 123 of the housing. Specifically, the seat 130 may be mounted by being fitted or press-fitted into a connection region between the connector 110 and the housing 120. The connection region may be an indented portion of the housing 120 formed by a top portion of an inner wall of the housing 120 being indented. The seat 130 is configured to maintain sealability while repeatedly coming into contact with the poppet 140, and the seat 130 is required to have excellent wear resistance and heat resistance. Therefore, the seat 130 may be made of not only a metallic material but also a plastic material with excellent elastic restoring force and chemical resistance. For example, thermoplastic resin, such as polyoxymethylene (POM), polytetrafluoroethylene (PTFE), or reinforced polyamide, may be used. However, the present disclosure is not limited thereto. Various materials may be selected depending on the use environment and required characteristics. The seat 130 may have a circular shape (e.g., disc). The seat 130 may have a through hole that may connect (e.g., communicate with) the first flow path (e.g., to a second flow path 142 described below). The diameter of the through hole of the seat 130 may narrow toward the top of the seat and widen toward the bottom of the seat.

The ventilation hole 170 may be formed in an inner peripheral surface (e.g., inner wall) of the seat 130 to suppress a leak of the fluid and control the internal pressure. In case that the poppet 140 and the seat 130 are attached to each other, a region in which the gasket 150 and a lower portion of the seat 130 adjoin each other to define sealability may be defined as a first region A, and a region in which an upper portion of the poppet 140 adjoins an upper portion of the seat 130 may be defined as a second region B. The ventilation hole 170 may run from the top of the seat 130 to the bottom of the seat 130. Therefore, the ventilation hole 170 may be formed in the second region B and communicate with a space between the upper portion of the poppet 140 and the upper portion of the seat 130, thereby preventing the internal pressure from being raised to a predetermined level or higher even in a state in which the poppet 140 does not move. Therefore, it is possible to effectively prevent chattering or opening inability caused by a pressure difference.

Specifically, the seat 130 may have a recessed section 170 having a shape recessed inward in a region of the inner peripheral surface of the seat 130 that faces the poppet 140. Therefore, the ventilation hole 170 may be formed at a separation space between the recessed section 170 and the poppet 140. In other words, the recessed section 170 provides a space through which the fluid may pass in the state in which the recessed section 170 is spaced apart (e.g., detached) from the poppet 140. Therefore, the recessed section 170 may serve as the ventilation hole 170. The recessed section 170 may be formed in a section having a partial angular position, instead of being formed along an overall circumference, around a central axis of the seat 130. Meanwhile, in order to ensure pressure distribution and flow balance under various pressure conditions and repetitive operating environments, the ventilation hole 170 may comprise a plurality of ventilation holes 170. The plurality of ventilation holes 170 are symmetrically arranged along an outer peripheral surface of the seat 130 and configured to uniformly distribute the flow of the fluid.

The poppet 140 may be movably disposed in the internal space 123 of the housing. Specifically, the poppet 140 may be configured to be rectilinearly movable in an upward/downward direction and selectively attached to or spaced apart (e.g., detached) from one side of the seat 130. Therefore, the operation of opening or closing the first flow path 114 may be performed. For example, the first flow path 114 may be closed in case that the poppet 140 is attached to the seat 130 (referred to as a closed valve position), and the first flow path 114 may be opened in case that the poppet 140 is spaced apart from the seat 130 (referred to as an open valve position). In other words, the poppet 140 may be configured to move between the closed valve position and the open valve position. If the poppet 140 is moved to or positioned at the closed valve position, the poppet 140 may create a seal (e.g., between the poppet 140 and the seat 130) and obstruct (e.g., block) the first flow path. If the poppet 140 is moved to or positioned at the closed valve position, the poppet 140 may also form the ventilation hole 170 between the poppet and the seat and along the recessed section 170 of the seat 130. Thus, the recessed section 170 of the seat 130 may not be in contact with the poppet 140 even when the poppet 140 is positioned at the closed valve position. If the poppet 140 is moved to or positioned at the open valve position, the poppet 140 may break (e.g., open, release, etc.) the seal (e.g., between the poppet 140 and the seat 130) and unblock the first flow path.

The poppet 140 may include all or some of a coupling portion 141, a second flow path portion 142, and an accommodation groove portion 143.

The coupling portion 141 may be formed in an upper region of the poppet 140 and coupled to the gasket 150 to provide sealability. Specifically, outer circumferential region the upper portion of the poppet 140 may include a groove 141b formed along an outer peripheral surface of the upper portion of the poppet 140. The groove 141b may be a ring-shaped groove. The groove 141b may have a shape in which an upper portion thereof has a smaller depth than a lower portion thereof. This shape may allow the gasket 150 to be stably coupled (e.g., affixed) without separating from the inside of the groove 141b.

The upper portion of the poppet 140 may have a first inclined surface 141a tapered toward the lower portion of the poppet 140. The first inclined surface 141a serves to stably ensure a contact area during a process in which the poppet 140 comes into contact with or separates from the seat 130. The first inclined surface 141a serves to allow the poppet 140 to be smoothly opened or closed in accordance with a change in pressure of the fluid.

The first inclined surface 141a may be formed to have an inclination angle of 30 degrees or more and 50 degrees or less with respect to a central axis of the poppet 140. More specifically, the first inclined surface 141a may be formed to have an inclination angle of 30 degrees or more and 50 degrees or less with respect to an imaginary vertical line N1 in a direction of the center axis of the poppet 140 that adjoins the first inclined surface 141a. In case that the inclination angle is less than 30 degrees, the poppet 140 may be excessively trapped into the seat 130 in a high-pressure state, which causes an opening/closing delay or adhesion. On the contrary, in case that the inclination angle is more than 50 degrees, fluid flow resistance increases, which causes a disadvantage in ensuring flow rate performance.

The upper portion of the seat 130 may have a second inclined surface 131 corresponding to the first inclined surface 141a of the poppet 140. The second inclined surface 131 is configured to be opposite to the first inclined surface 141a of the poppet 140, such that the first inclined surface 141a and the second inclined surface 131 are attached to each other during the process in which the poppet 140 is raised or lowered, thereby forming stable sealability.

The lower portion of the seat 130 may have a third inclined surface 132 corresponding to one surface of the gasket 150. The third inclined surface 132 may be formed to have a smaller angle than the first inclined surface 141a around the central axis of the poppet 140. In other words, the third inclined surface 132 may be formed to have a smaller angle than the first inclined surface 141a based on an imaginary vertical line in the direction of the center axis of the poppet 140 that adjoins the third inclined surface 132.

Meanwhile, the poppet 140 may be configured to be rectilinearly movable by an elastic force of the spring 160 and made of a material with excellent wear resistance and heat resistance so that the poppet 140 may maintain the shape and strength even under repetitive operating environments. For example, the poppet 140 may be made of a material such as stainless steel (e.g., SUS304 or SUS316), hard-coated aluminum alloy, or engineering plastic with corrosion resistance and high-strength characteristics. However, the present disclosure is not limited to the material of the poppet 140. An appropriate material may be selected depending on conditions such as working pressure, temperature, and fluid type.

The gasket 150 may be provided at outer circumferential region the upper portion of the poppet 140. The gasket 150 may be, for example, a gasket, an O-ring, a packing, and/or a toric joint. The gasket 150 may be disposed to be attached to the seat 130. The gasket 150 may be inserted and fixed into the groove 141b. Therefore, the groove 141b may have a tapered shape having a depth that gradually decreases from below to above. An upper portion 151 of the gasket may be formed to have a smaller depth than a lower portion 152 of the gasket so that the gasket 150 may also correspond to the shape of the groove 141b. Therefore, the gasket 150 may be attached to an inner surface of the groove 141b and stably fixed without being easily separated by an external force. For example, the gasket 150 may be formed in a ring shape and disposed in a circumferential direction along an outer periphery of the poppet 140. Therefore, the gasket 150 may be mounted by being press-fitted or fitted into the groove 141b and stably maintain a position thereof even under impact environments caused by repetitive opening/closing operations or external forces.

In addition, the gasket 150 may be made of a material having a higher elastic force than those of the seat 130 and the poppet 140. For example, the gasket 150 may be made of a highly elastic material such as ethylene propylene diene monomer (EPDM) or thermoplastic polyurethane (TPU). This material may maintain an elastic restoring force for a long period of time even under repetitive opening/closing environments, thereby exhibiting excellent effects in terms of sealability and durability. However, the present disclosure is not limited in the choice of the material being used for the gasket 150. Various elastic materials may be applied depending on usage conditions.

A partial region 153 of an outer portion of the gasket 150 may have a fourth inclined surface 153 corresponding to the third inclined surface 132 formed on the lower portion of the seat 130. Therefore, the gasket 150 may be attached to the third inclined surface 132 and maintain excellent sealability even during the repetitive opening/closing operations.

The remaining region 154 of the outer portion of the gasket 150 may extend along a depth corresponding to a depth of a lower portion of the groove 141b formed on an outer peripheral surface of the poppet 140. That is, the remaining region of the outer portion of the gasket 150 is formed to have the depth corresponding to the depth of the lower portion of the groove 141b, such that the remaining region of the outer portion of the gasket 150 may be stably seated in the groove 141b and prevented from being separated in position during the repetitive operations.

The second flow path portion 142 may be formed on the central portion of the poppet 140. The second flow path portion 142 may include a second flow path 142b inclined downward and inward from the outer peripheral surface of the poppet 140 in order to guide the fluid into the poppet 140 (e.g., into an interior space of the poppet 140). More specifically, an inlet 142a of the second flow path portion may be formed outside the central portion. The inlet 142a of the second flow path portion may communicate with the second flow path 142b formed to be inclined inward from the outer peripheral surface of the poppet 140.

The second flow path 142b may be formed to be inclined downward so that the flow of the fluid is directed toward the central axis of the poppet 140. The inlet 142a of the second flow path portion may comprise a plurality of inlets 142a. The inlets 142a of the plurality of second flow path portions may be disposed outside the central portion of the poppet 140 and spaced apart (e.g., detached) from one another at predetermined intervals. The second flow paths 142b, which communicate with one another, may be formed in the inlets 142a of the second flow path portions and extend to be inclined downward in a direction toward the center of the poppet 140. Therefore, the plurality of second flow paths 142b may be disposed in a structure in which the plurality of second flow paths 142b gradually converge toward an accommodation groove 143a positioned in the lower portion of the poppet 140. That is, the plurality of second flow paths 142b are disposed in the inclined direction toward an outlet 142c of the second flow path portion positioned at a lower side of the central portion of the poppet 140, thereby forming a continuous flow without a collision between the flow paths or stagnation.

In addition, the fluid introduced through the plurality of second flow paths 142b may be connected to an external component through the accommodation groove 143a of the lower portion of the poppet 140 and the flow path configured to communicate with the lower portion of the check valve 100.

The accommodation groove portion 143 may be formed on the lower portion of the poppet 140. The accommodation groove 143a may be formed in the accommodation groove portion 143 and opened so that at least a part of the spring 160 may be inserted into the accommodation groove 143a and the fluid may pass through the accommodation groove 143a. The accommodation groove 143a may be configured to guide the flow of the fluid therethrough.

The spring 160 may be disposed in the internal space 123 of the housing and elastically support (e.g., apply an elastic force or pressure to) the poppet 140 in a direction in which the first flow path 114 is closed (e.g., the direction in which the poppet 140 closes the first flow path 114).

The poppet 140 is configured to be movable upward or downward by an external force or fluid pressure. The spring 160 serves to provide a restoring force in a direction in which the poppet 140 closes the first flow path 114, thereby preventing a reverse flow of the fluid. The spring 160 may be configured to be at least partially inserted into the accommodation groove 143a formed in the lower portion of the poppet 140, thereby ensuring the position stability of the poppet 140 and improving performance in mitigating impact and maintaining sealability during the opening/closing operation of the poppet 140.

In particular, the sealability may be maintained and the opening/closing resistance may be dispersed by the gasket 150, which is inserted into the groove 141b, and by the ventilation hole 170 formed between the poppet 140 and the seat 130, such that a load of the spring 160 may be designed to be low. Therefore, a difference between pressurization pressure at a filling station and final filling pressure in the hydrogen tank in the vehicle may be minimized, such that a high state of fill (SOF) of the vehicle may be maintained after the filling is completed. At the same time, the chattering caused by unstable vibration of the poppet 140 may be effectively suppressed.

In addition, a spring constant of the spring 160 may be optimized in consideration of operating pressure conditions, the weight of the poppet 140, a viscosity of the fluid, and the like, and the spring 160 may be made of a material with excellent fatigue resistance to maintain a predetermined elastic force even in repetitive operating environments. For example, the spring 160 may be made of stainless steel (SUS304 or SUS316) or alloy steel with excellent corrosion resistance. However, the present disclosure is not limited in the choice of the material being used for the spring 160. Various elastic materials may be applied depending on usage conditions.

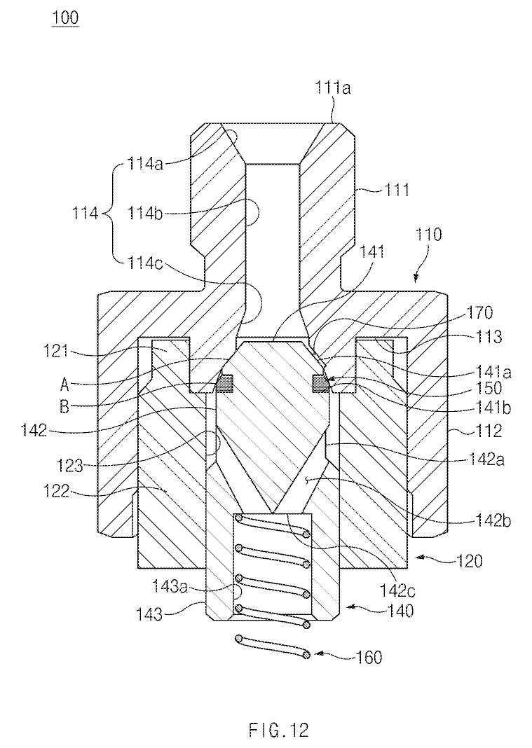

FIG. 12 is a cross-sectional view illustrating an example check valve, in which a connector and a seat are integrated. The example check valve shown in FIG. 12 may be similar to the example check valve in FIG. 4 but with some differences. Descriptions of any component that is identical to that of the example check valve as illustrated in FIG. 4 will be omitted.

With reference to FIG. 12, the seat 130 may be integrated with the connector 110. Specifically, the seat 130 may be formed integrally in a shape protruding inward from (e.g., form a ridge on) one side of the inner lower portion 113 of the connector. That is, because the connector 110 and the seat 130 are integrated, the number of components may be reduced, the assemblability may be improved, and the separation or damage caused by repetitive opening/closing operations or external impact may be prevented. For example, because the seat 130 is integrated with (e.g., into) the connector 110, the seat 130 may be made of a metallic material such as stainless steel or brass. However, the present disclosure is not limited thereto. Various materials may be selected depending on the use environment and required characteristics.

In addition, the seat 130 may have the recessed section 170 having a shape recessed inward in the region of the inner peripheral surface of the seat 130 that faces the poppet 140. In other words, an inner peripheral surface of the seat 130 may face the poppet 140 and have the recessed section 170 that is recessed inward (e.g., having a smaller thickness than the areas or regions around it). Therefore, the ventilation hole 170 may be formed at a separation space between the recessed section 170 and the poppet 140 (e.g., the ventilation hole 170 may be formed at a space between the recessed section 170 and the poppet 140). In other words, the recessed section 170 provides a space through which the fluid may pass in the state in which the recessed section 170 is spaced apart (e.g., detached) from the poppet 140. Therefore, the recessed section 170 may serve as the ventilation hole 170. The recessed section 170 may be formed only in a partial section of the poppet 140, instead of being formed along an overall circumference of the poppet 140, based on (e.g., with respect to, around, etc.) a central axis of the connector 110. In other words, the poppet 140 may have the recessed section 170 formed in some regions (e.g., having one or more partial angular positions) around the central axis of the connector 110 but lack the recessed section 170 in other regions (e.g., angular positions) around the central axis of the connector 110. The ventilation hole 170 may comprise a plurality of ventilation holes 170. The plurality of ventilation holes 170 are symmetrically arranged along the outer peripheral surface of the seat 130 and configured to uniformly distribute the flow of the fluid.

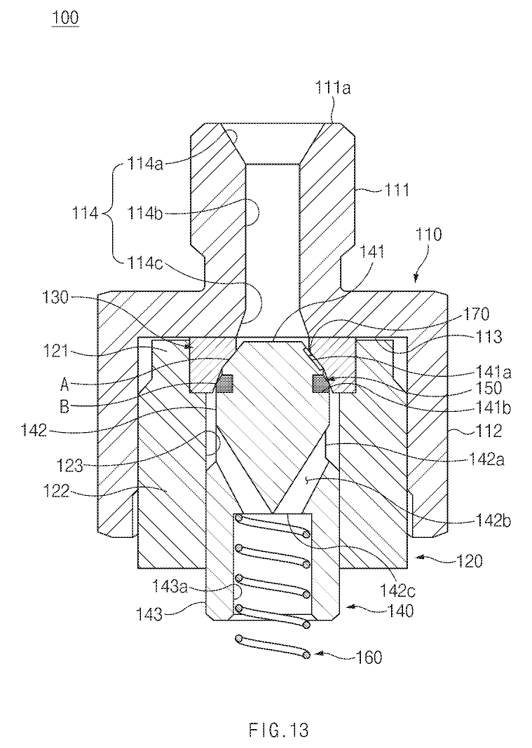

FIG. 13 is a cross-sectional view illustrating an example check valve with a ventilation hole formed in the poppet. The example check valve shown in FIG. 13 may be similar to the example check valve in FIG. 4 but with some differences. Descriptions of any component that is identical to that of the example check valve as illustrated in FIG. 4 will be omitted.

With reference to FIG. 13, the upper portion of the poppet 140 may have the recessed section 170 having a shape recessed inward in a region of the inner peripheral surface of the upper portion of the poppet 140 that faces the seat 130. Therefore, the ventilation hole 170 may be formed at a separation space between the recessed section 170 and the seat 130. In other words, the recessed section 170 provides a space through which the fluid may pass in the state in which the recessed section 170 is spaced apart (e.g., detached) from the seat 130. Therefore, the recessed section 170 may serve as the ventilation hole 170.

The upper portion of the poppet 140 is recessed inward only in a partial region based on the central axis, and the separation space formed by the recession may be formed as a substantial ventilation path configured to allow the internal space of the poppet 140 and the upper portion of the seat 130 to communicate with each other. The above-mentioned structure may effectively mitigate a pressure difference between the upper and lower portions of the poppet 140, and particularly, suppress a likelihood of erroneous operations such as an opening/closing delay, adhesion, or chattering noise of the poppet 140.

For example, because the poppet 140 generally requires high durability and precise processability, the poppet 140 may be made of a metallic material such as stainless steel (STS304 or STS316) or aluminum alloy with corrosion resistance. However, depending on the intended purpose and operational environment, the poppet 140 may be made of a plastic material with excellent chemical resistance or wear resistance, e.g., thermoplastic resin such as polyoxymethylene (POM), polytetrafluoroethylene (PTFE), or reinforced polyamide (PA6+GF, etc.). Therefore, the present disclosure is not limited in the choice of the material being used for the poppet 140, and the range of material selection may be expanded to suit various operating conditions.

A check valve according to the present disclosure may include a connector comprising an inlet port, wherein the inlet port is configured to receive a fluid therethrough, and wherein a first flow path is formed in the connector, a housing coupled to an inner lower portion of the connector and configured to couple to an external pipe, a seat disposed between the inner lower portion of the connector and an inner upper portion of the housing, a poppet movably disposed in an internal space of the housing and configured to close the first flow path based on the poppet being attached to the seat, or open the first flow path based on the poppet being detached from the seat, a gasket provided at an upper portion of the poppet and attached to the seat, a spring disposed in the internal space of the housing and configured to apply an elastic force to the poppet in a direction in which the first flow path is closed, and a ventilation hole formed in at least one of the seat or the poppet.

In the check valve, when a region in which the gasket and a lower portion of the seat adjoin each other to define sealability is defined as a region in which, based on the poppet being positioned to attach to the seat, the upper portion of the poppet adjoins an upper portion of the seat, the ventilation hole may be formed in the region and allow the upper portion of the poppet and the upper portion of the seat to communicate with each other.

The seat may have a recessed section having a shape recessed inward in a region of an inner peripheral surface of the seat that faces the poppet, and the ventilation hole may be formed at a separation space between the recessed section and the poppet.

The recessed section may be formed in a section having a partial angular position around a central axis of the seat.

The upper portion of the poppet may have a recessed section having a shape recessed inward in a region of an inner peripheral surface of the upper portion of the poppet that faces the seat, and the ventilation hole may be formed at a separation space between the recessed section and the seat.

The recessed section may be formed in a section having a partial angular position around a central axis of the poppet.

The seat may be integrated with the connector and forms a ridge on the inner lower portion of the connector.

The seat may have a recessed section having a shape recessed inward in a region of an inner peripheral surface of the seat that faces the poppet, and the ventilation hole may be formed at a separation space between the recessed section and the poppet.

The recessed section may be formed in a section having a partial angular position around a central axis of the connector.

A lower portion of the connector may form a sleeve around at least a part of the housing.

A groove may be formed along an outer peripheral surface of the upper portion of the poppet, and the gasket may be inserted into the groove and disposed in a ring shape along an outer peripheral surface of the poppet.

The groove may have a shape in which an upper portion thereof has a smaller depth than a lower portion thereof.

The connector may include: a first flow path portion disposed on a central portion of the connector and forming at least part of the first flow path; an upper end inclined expansion portion disposed at an upper end of the connector where a diameter of the first flow path expands toward the inlet port; and a lower end inclined expansion portion disposed at a lower end of the connector, wherein the diameter of the first flow path expands toward the inner lower portion of the connector.

An upper portion of the poppet may have a first inclined surface tapered toward a lower portion of the poppet, and an upper portion of the seat may have a second inclined surface corresponding to the first inclined surface.

The first inclined surface may have an inclination angle of 30 degrees or more and 50 degrees or less with respect to a central axis of the poppet.

A lower portion of the seat may have a third inclined surface corresponding to a surface of the gasket, and the third inclined surface may be formed to have a smaller angle than the first inclined surface with respect to a central axis of the poppet.

The ventilation hole may comprise a plurality of ventilation holes symmetrically disposed along an outer periphery of the poppet.

The poppet may include: a coupling portion formed on the upper portion of the poppet and coupled to the gasket; a second flow path formed on a central portion of the poppet and formed to be inclined downward and inward from an outer peripheral surface of the poppet to guide the fluid into an interior space of the poppet; and an accommodation groove formed on a lower portion of the poppet and opened so that at least a part of the spring is inserted into the accommodation groove, wherein the accommodation groove is configured to guide a flow of the fluid.

The gasket is disposed between the seat and the poppet, such that the seat and the poppet may be stably and attached to each other even in a large pressure section, thereby ensuring sealability.

With the groove, which is formed in the outer peripheral surface of the poppet, the gasket, which is inserted into the groove, and the ventilation hole structure, the elasticity of the sealed portion may be ensured, and the spring load may be designed to be low, such that a high state of fill (SOF) of the vehicle may be maintained after the filling is completed, and the occurrence of chattering may be suppressed.

With the recessed section, which is formed in the poppet or the seat, and the ventilation hole structure defined at the separation space, clogging caused by foreign substances may be prevented, and the sealing structure may not be damaged even in repetitive operating environments, thereby improving durability.

While one or more example embodiments have been described above, the example embodiment(s) are merely illustrative and not intended to limit the present disclosure. It can be appreciated by those skilled in the art that various modifications and applications, which are not described above, may be made to the example embodiment(s) without departing from the intrinsic features of the present disclosure. For example, the respective constituent elements specifically described in the example embodiment(s) may be modified and then carried out. Further, it should be interpreted that the differences related to the modifications and applications are included in the scope of the present disclosure defined by the appended claims.

What is claimed is:

1. A check valve comprising:
a connector comprising an inlet port, wherein the inlet port is configured to receive a fluid therethrough, and wherein a first flow path is formed in the connector;
a housing coupled to an inner lower portion of the connector and configured to couple to an external pipe;
a seat disposed between the inner lower portion of the connector and an inner upper portion of the housing;
a poppet movably disposed in an internal space of the housing and configured to:
close the first flow path based on the poppet being attached to the seat, or
open the first flow path based on the poppet being detached from the seat;
a gasket provided at one side of an upper portion of the poppet and attached to the seat;
a spring disposed in the internal space of the housing and configured to apply an elastic force to the poppet in a direction in which the poppet closes the first flow path; and
a ventilation hole formed in at least one of the seat or the poppet.

2. The check valve of claim 1, wherein the ventilation hole is formed in a region in which, based on the poppet being positioned to attach to the seat, the upper portion of the poppet adjoins an upper portion of the seat to allow the upper portion of the poppet to communicate with the upper portion of the seat.

3. The check valve of claim 2, wherein an inner peripheral surface of the seat faces the poppet and has a recessed section that is recessed inward, and
wherein the ventilation hole is formed at a space between the recessed section and the poppet.

4. The check valve of claim 3, wherein the recessed section is formed in a section having a partial angular position around a central axis of the seat.

5. The check valve of claim 2, wherein an inner peripheral surface of the upper portion of the poppet faces the seat and has a recessed section that is recessed inward, and
wherein the ventilation hole is formed at a space between the recessed section and the seat.

6. The check valve of claim 5, wherein the recessed section is formed in a section having a partial angular position around a central axis of the poppet.

7. The check valve of claim 1, wherein the seat is integrated with the connector and forms a ridge on the inner lower portion of the connector.

8. The check valve of claim 7, wherein an inner peripheral surface of the seat faces the poppet and has a recessed section that is recessed inward, and
wherein the ventilation hole is formed at a space between the recessed section and the poppet.

9. The check valve of claim 8, wherein the recessed section is formed in a section having a partial angular position around a central axis of the connector.

10. The check valve of claim 1, wherein a lower portion of the connector forms a sleeve around at least a part of the housing.

11. The check valve of claim 1, wherein a groove is formed along an outer peripheral surface of the upper portion of the poppet, and
wherein the gasket is inserted into the groove and disposed in a ring shape along the outer peripheral surface of the upper portion of the poppet.

12. The check valve of claim 11, wherein an upper portion of the groove has a smaller depth than a lower portion of the groove.

13. The check valve of claim 1, wherein the connector comprises:
a first flow path portion disposed on a central portion of the connector and forming at least part of the first flow path;
an upper end inclined expansion portion disposed at an upper end of the connector where a diameter of the first flow path expands toward the inlet port; and
a lower end inclined expansion portion disposed at a lower end of the connector, wherein the diameter of the first flow path expands toward the inner lower portion of the connector.

14. The check valve of claim 1, wherein an upper portion of the poppet has a first inclined surface tapered toward a lower portion of the poppet, and
wherein an upper portion of the seat has a second inclined surface corresponding to the first inclined surface.

15. The check valve of claim 14, wherein the first inclined surface has an inclination angle of 30 degrees or more and 50 degrees or less with respect to a central axis of the poppet.

16. The check valve of claim 14, wherein a lower portion of the seat has a third inclined surface corresponding to a surface of the gasket, and
wherein the third inclined surface is formed to have a smaller angle than the first inclined surface with respect to a central axis of the poppet.

17. The check valve of claim 1, wherein the ventilation hole comprises a plurality of ventilation holes symmetrically disposed along an outer periphery of the poppet.

18. The check valve of claim 1, wherein the poppet comprises:
a coupling portion formed on the upper portion of the poppet and coupled to the gasket;
a second flow path formed on a central portion of the poppet and formed to be inclined downward and inward from an outer peripheral surface of the poppet to guide the fluid into an interior space of the poppet; and
an accommodation groove formed on a lower portion of the poppet and opened so that at least a part of the spring is inserted into the accommodation groove, wherein the accommodation groove is configured to guide a flow of the fluid.

19. A check valve comprising:
a connector through which a first flow path is formed, wherein the connector comprises:
an inlet port coupled to the first flow path and configured to receive a liquid therethrough; and
a sleeve disposed below the inlet port and comprising a tubular inner wall and an open bottom, wherein the tubular inner wall of the sleeve forms an interior space, of the connector, that communicates with the first flow path;
a cylindrical housing disposed in the interior space of the sleeve and coupled to the tubular inner wall of the sleeve, wherein a top portion of an inner wall of the cylindrical housing is indented to form an indented portion of the cylindrical housing;
a seat disposed between the sleeve of the connector and the indented portion of the cylindrical housing, wherein the seat has a circular shape and a through hole, wherein a diameter of the through hole narrows toward a top of the seat and widens toward a bottom of the seat, and wherein an inner wall of the seat has a recessed section that runs from the top of the seat to the bottom of the seat; and
a poppet disposed inside the cylindrical housing and configured to:
move to a closed valve position to:
create a seal between the poppet and the seat and obstruct the first flow path, and
form a ventilation hole between the poppet and the seat and along the recessed section of the seat, or
move to an open valve position to break the seal between the poppet and the seat and unblock the first flow path.

20. The check valve of claim 19, wherein a ring-shaped groove is formed around the poppet,
wherein the poppet comprises a gasket mounted along the ring-shaped groove, and
wherein, based on the poppet being positioned at the closed valve position:
the seal is created between the gasket and the seat, and
the recessed section of the seat is not in contact with the poppet.
